(19) United States
(12) Patent Application Publication
(10) Pub. No.: US 2002/0133239 A1
(43) Pub. Date: Sep. 19, 2002

(54) Device for connecting an industrial control unit to an industrial control panel

(75) Inventors: Matthias Rebellius, Erlangen (DE); Thomas Steinhorst, Dietenhofen (DE); Matthias Reinert, Kalchreuth (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/055,989

(22) Filed: Jan. 28, 2002

Related U.S. Application Data
(63) Continuation of application No. PCT/DE00/02243, filed on Jul. 10, 2000.

(30) Foreign Application Priority Data
Jul. 28, 1999 (DE) 199 35 512.6

(51) Int. Cl. G05B 15/00

(52) U.S. Cl. 700/1

(57) ABSTRACT

A device and method for connecting an industrial control unit (1) to an industrial control panel (2). The control panel has several functional units (4, 5, 7, 8), each of which is equipped with a USB controller (4a, 5a, 7a, 8a) and the USB controllers are connected to a USB hub (9) which can be integrated into the control panel. The USB hub is connected to the industrial control unit via a single communication link (1b) such that control signals can be sent to and from the control unit from or to the control panel in a simple, economical manner.

This is a Continuation of International Application PCT/DE00/02243, with an international filing date of Jul. 10, 2000, which was published under PCT Article 21(2) in German, and the disclosure of which is incorporated into this application by reference.

### FIELD OF AND BACKGROUND OF THE INVENTION

The present invention relates generally to a device having an industrial control unit, an industrial control panel, and a communication link. More specifically, the present invention is directed to a device and method for providing a simple and economical communication interface between functional units of an industrial control panel and an industrial control unit.

Industrial control panels generally have several front-mounted functional units in addition to a flat display which serves as a display unit. In particular, these functional units include, (i) an operator keyboard which can be designed as a membrane keyboard or short-stroke keyboard, (ii) a touch screen input unit for the display-controlled input of user commands, (iii) a mouse, or—as a substitute for a mouse—a pointer, for example in the form of a touch pad, roller ball, or piezo pad, (iv) status displays, which can be designed as LEDs, and (v) key displays which give the user information on current allowed and disallowed operations, for example. The functional units may also be communication interfaces for the connection of additional control devices and output devices such as bar code readers, printers, and an operator keyboard, and for the temporary connection of mass storage devices such as CD-ROM drives, CD-ROM burners, LS120 drives, and zip drives.

The functional units of a control panel are each connected to an industrial control unit via individual communication links, using a corresponding number of lines. This industrial control unit controls a technical process such as an industrial production device, and can be designed as a memory-programmable control or an industrial PC, for example. Conventionally, connections between the control panel and the control unit have been made by using different protocols and different interfaces on the side of the industrial control unit, such as COM1, COM2, LPT, PS2 mouse, PS2 keyboard, an FD interface, and/or an ATAPI CD-ROM interface, and occasionally, non-standardized proprietary customized solutions. There are disadvantages to this approach, however, such as a marked reduction in the allowed line length, and limited industrial suitability, such as low resistance to interference in the connecting lines due to the physical transmission characteristics.

The fundamentals for data transmission using USB interfaces are known from a publication by G. Bassak, “USB Eases Data Acquisition” from Test and Measurement World, Vol. 18, No. 6, and a publication by M. Rowe, “USB Proves Ready for T & M Tasks.” U.S. Pat. No. 5,675,813 describes a system and a method for power transmission to a computer via a USB bus system.

### OBJECTS OF THE INVENTION

One object of the invention, therefore, is to provide a device having an industrial control unit, an industrial control panel, and a communication link that does not have the aforementioned disadvantages. A further object is to provide an industrial control panel that does not have the aforementioned disadvantages.

### SUMMARY OF THE INVENTION

In accordance with the present invention, the above-mentioned objects, as well as other objects, are achieved by a device having an industrial control unit, an industrial control panel and a communication link. The industrial control panel further has at least two functional units, each of which has a respective USB controller. The control panel also has an integrated USB hub which connects the USB controllers to the respective functional units of the control panel. Also, the industrial control panel is connected to the industrial control unit via the communication link such that control signals can be sent to or from the control unit from or to the control panel and its corresponding functional units via the USB hub.

One of the advantages of the present invention lies in the fact that the control panel can be connected to the industrial control unit via a single communication link. Examples of an industrial control unit include an office PC, an industrial PC, or an embedded computer. Since the allowed line length of this communication link is significantly increased compared to known connections between industrial control units and industrial control panels, the claimed device simultaneously satisfies the requirements of installing the control panel spatially separate from the industrial control unit and-in addition to a flat display line and the power supply—connecting to the industrial control unit via a single, inexpensive two-wire connection. A device in accordance with the present invention allows limited installation space or special environmental conditions to be taken into consideration, if necessary.

Furthermore, the hub functionality employed in the claimed connection allows several control panels to be simultaneously connected to a single industrial control unit via a single connecting line. This assures the unambiguous identification of the respective control components within the overall system.

### BRIEF DESCRIPTION OF THE DRAWINGS

The invention and further advantageous refinements of the invention according to the features of the dependent claims are explained in more detail below with the aid of diagrammatic, exemplary embodiments in the drawing, in which:

FIG. 1 illustrates a device in accordance with one embodiment of the present invention comprising an industrial control unit, an industrial control panel, and a communication link according to the invention, and

FIG. 2 shows a device comprising an industrial control unit and an industrial control panel according to a further embodiment of the invention.

### DETAILED DESCRIPTION OF THE PREFERRED EMBODIMENTS

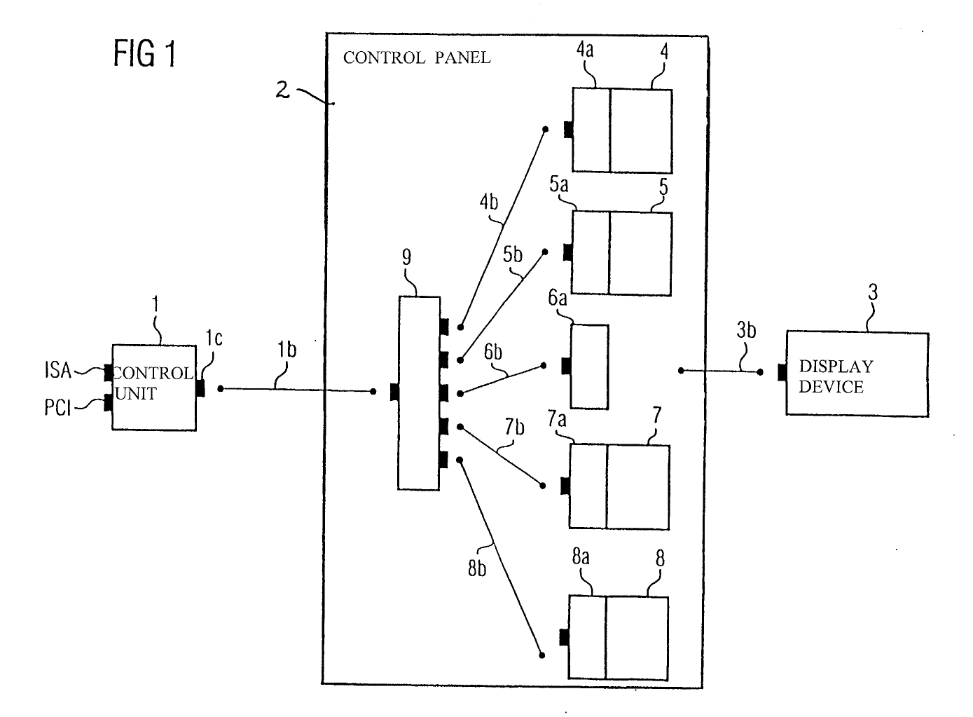

FIG. 1 shows a device with an industrial control unit 1 and an industrial control panel 2. The control panel has several functional units 4, 5, 7, 8. Reference number 4 represents a mouse, for example, reference number 5 represents a touch screen input unit, for example, reference number 7 represents a light diode status display, for example, and reference number 8 represents an input keyboard, for example. Each of these functional units is assigned its own respective USB controller 4a, 5a, 7a, 8a which converts data present in each of the functional units into USB format, and vice versa. The term “USB format” refers to a data format which has become standardized in the personal computer field, and which performs serial data conversion on a universal serial bus (USB).

Each of the USB controllers 4a, 5a, 7a, 8a is connected to a USB hub 9, which is integrated into the control panel 2. The USB hub relays data sent to it by the functional units, together with the respective associated address information, to a single communication link lb. Communication link 1b is preferably a USB line and is connected to a USB interface 1c of the industrial control unit 1.

The control panel 2 also has a front USB interface 6a which is connected to an additional device. The additional device can be an external control device (not shown), a display device 3, or an external mass storage device (not shown). The external mass storage device can be, for example, a printer, external keyboard, external mouse, external bar code reader, PC-PC coupling, CD-ROM device, CD burner, LS120 floppy disk drive, IOMEGA zip drive, or any other compatible device.

Thus, according to the present invention each of the functional units present in the control panel 2 is connected via individual USB controllers to an integrated USB hub 9, which in turn is connected via a single USB line 1b to the industrial control unit 1. The advantages of such a device lie in the fact that a simple and economical communication link is created via only a single line 1b to the industrial control unit 1, at which location a standardized USB interface can be used. Hence, commercially available drivers, such as drivers for the Microsoft Windows operating system, can be used in conjunction with the present invention. Furthermore, in accordance with the invention, additional external control, output, and mass storage devices can be connected to the industrial control unit 1 via the control panel 2. Since the allowed line length of USB line 1b is greater than 5 meters, the control panel 2 can also be installed spatially separate from the industrial control unit 1.

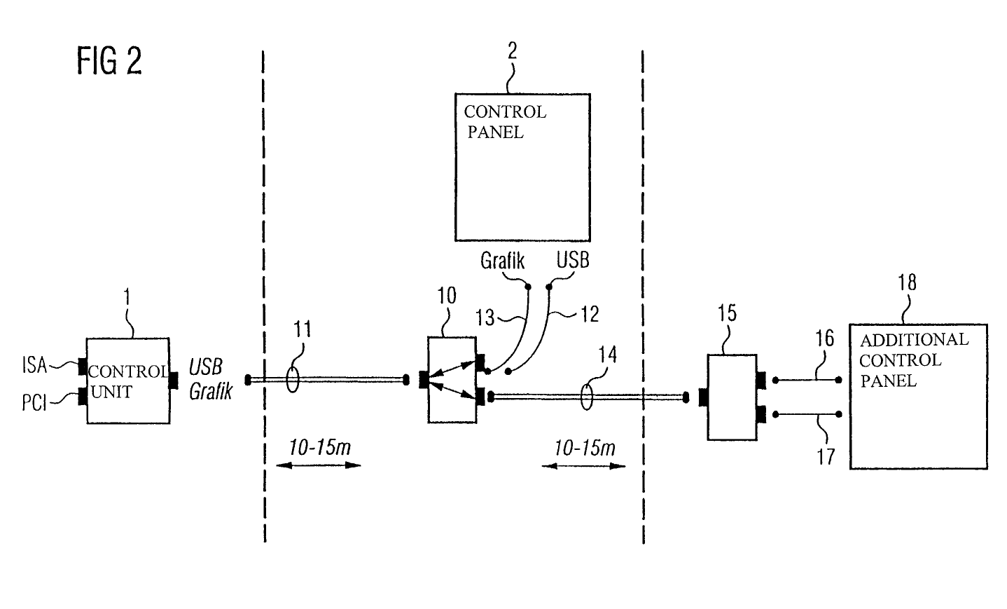

FIG. 2 shows a device for connecting an industrial control unit 1 to an industrial control panel 2 according to a further embodiment of the invention. According to this embodiment, an additional USB hub 10 is assigned to the control panel 2. The additional hub may be provided spatially separate from the control panel, or it may be integrated into the control panel. The additional USB hub 10 is connected to the functional units of the control panel 2 via a first USB line 12. In addition, graphics data is transmitted between the control panel 2 and the USB hub 10 via a line 13.

The additional USB hub 10 is also connected to an external receiver 15 via a cable 14, with the cable comprising a USB line and a graphics line. The receiver 15 is connected to an additional control panel 18 via a USB line 16 and a graphics line 17. Control panels 2 and 18, shown in FIG. 2, have the same design as control panel 2, previously described in conjunction with FIG. 1.

The additional USB hub 10 is connected to the industrial control unit 1 via a cable 11 which has a USB line and a graphics line. The lengths of the respective cables 11 and 14 can vary from 10 to 15 meters. Thus, in this exemplary embodiment two control panels which are installed at separate locations are connected via USB lines to an industrial control unit 1 which is spatially separate from the control panel 2. Accordingly, only a single cable leading to the industrial control unit 1 is necessary. A USB hub installed near or in the control panel is used to distribute data fed to the various control panels and to combine data sent from the control panels.

The above description of certain embodiments of the present invention has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A device comprising:
an industrial control unit;
an industrial control panel; and
a communication link;
wherein said industrial control panel comprises a plurality of functional units, each of which is furnished with a respective USB controller, and an integrated USB hub operable to connect the USB controllers to the respective functional units, and wherein further, said industrial control panel is connected to said industrial control unit via said communication link.

2. A device according to claim 1, wherein said industrial control unit comprises a USB interface, and said communication link is a USB line that is connected to the USB interface of said industrial control unit.

3. A device according to claim 1, wherein the functional units are input and output components.

4. A device according to claim 3, wherein the functional units are selected from a group comprising an operator keyboard, a touch screen input unit, a status display, a key display, a touch pad, a roller ball, and a piezo pad.

5. A device according to claim 1, wherein the functional units comprise a communication interface operable to connect additional control devices and output devices or for temporary connection of mass storage devices.

6. A device according to claim 1, wherein a line length of said communication link is greater than 5 meters.

7. A device according to claim 1, wherein the USB hub is connected to said industrial control unit via a two-wire connection.

8. A device according to claim 1, further comprising:
an additional USB hub assigned to said control panel, said additional USB hub being connected to the functional units of said control panel via a first USB line, and connected to the functional units of at least one additional control panel via a second USB line, and connected to said industrial control unit via a third USB line.

9. A device according to claim 8, wherein said additional USB hub is physically integrated into said control panel.

10. An industrial control panel comprising:
a plurality of functional units, each of which is associated with a respective USB controller; and
an integrated USB hub operable to inter-connect the USB controllers of the functional units,
wherein said industrial control panel is connected to a secondary device via a communication link operably connected to said integrated hub.

11. An industrial control panel according to claim 10, wherein said functional units are input and output components.

12. An industrial control panel according to claim 11, wherein said functional units are selected from a group comprising an operator keyboard, a touch screen input unit, a status display, a key display, a touch pad, a roller ball, and a piezo pad.

13. An industrial control panel according to claim 10, wherein said functional units comprise a communication interface operable to connect additional control devices and output devices or for temporary connection of mass storage devices to the industrial control panel.

14. A method for sending control signals within an industrial facility, said method comprising:
providing an industrial control unit;
providing an industrial control panel having a plurality of functional units, each functional unit having a respective USB controller; and
operably connecting said industrial control unit to each of the plurality of functional units via a USB hub having a panel connection with a corresponding connection for each of the functional units and a control unit connection for sending or receiving control signals to or from said industrial control unit.

15. A method for sending control signals as set forth in claim 14, further comprising:
providing a front USB interface device;
providing an external device;
operably connecting the external device to the USB hub through the front USB interface device; and
sending control or data signals to the external device from the industrial control unit via the USB hub and the front USB interface device.
